(19) United States
(12) Patent Application Publication
(10) Pub. No.: US 2016/0137473 A1
(43) Pub. Date: May 19, 2016

(54) CONTINUOUS PACKAGING PROCESS USING ULTRAVIOLET C LIGHT TO STERILIZE BOTTLES

(71) Applicants: Alex GUAMIS ALEGRE, Barcelona (ES); David GUAMIS ALEGRE, Barcelona (ES); Leo MORETA BUFILL, Barcelona (ES); Antonio ALMAGRO GARCÍA, Barcelona (ES); José RIZO CLARAVALLS, Barcelona (ES)

(72) Inventors: Alex GUAMIS ALEGRE, Barcelona (ES); David GUAMIS ALEGRE, Barcelona (ES); Leo MORETA BUFILL, Barcelona (ES); Antonio ALMAGRO GARCIA, Barcelona (ES); Jose RIZO CLARAVALLS, Barcelona (ES)

(21) Appl. No.: 14/899,192

(22) PCT Filed: Jun. 5, 2014
(86) PCT No.: PCT/EP2014/061741

§ 371 Date: Dec. 17, 2015

(30) Foreign Application Priority Data
Jun. 21, 2013 (EP) 13382235.3

(51) Int. Cl. B67C 7/00; B67C 3/02

(52) U.S. Cl. CPC B67C 7/0073; B67C 3/02; B67C 2003/227

(57) ABSTRACT

Continuous packaging process, in aseptic conditions, which uses UV-C light to sterilise bottles and closure caps which are intended to contain alimentary, cosmetic and pharmaceutical products, wherein the entire internal surface of the bottles is innovatively sterilised by means of lamps specially formed to be introduced through the mouth of the bottles, thus preventing irradiation blind spots, along with preliminary bottle preparation and formation, cap removal, filling and closing stages.

### OBJECT OF THE INVENTION

The present invention refers to a continuous packaging process, which uses a high strength ultraviolet-C(UV-C) light source, in aseptic conditions, to sterilise the entire internal surface of those bottles intended to contain alimentary, cosmetic and pharmaceutical products.

The continuous process described herein involves, in addition to sterilisation by means of UV-C light, a preliminary bottle preparation and/or formation stage and final bottle filling and capping stages in aseptic conditions.

### BACKGROUND OF THE INVENTION

Although the aseptic packaging of food, cosmetics, drugs etc., gained importance over the past two decades, its origins date back to the turn of the twentieth century (1914), when sterilisation filters were developed for transparent liquids. At the end of the First World War, sterilised milk was successfully packaged aseptically in Denmark, following a process which was previously unknown.

In the 1940s, work that lead to the development of a production system for can packaging sterilised by means of superheated steam began. In 1962, the first Tetra Pak machine was set into operation and ever since, this system has spread across the globe, with almost 40 years of experience.

PET (polyethylene terephthalate), PE (polyethylene), PP (polypropylene), glass etc., type bottle packaging devices have played a significant role in the market to date, be it owing to economic or marketing factors or to consumer preference, the need to obtain secure and reliable aseptic packaging processes having developed from here.

Over the years, a large number of sterilisation processes have been researched for packaging and container materials; some of them are used today in practical applications. These processes are subdivided into chemical and physical processes and may also be combined.

One of the most frequently employed chemical processes available is the use of immersion baths, aerosols, using hydrogen peroxide (H₂O₂) steam at concentrations of above 20%, at temperatures of between 80 and 85° C. and/or using peracetic acid (CH3COOOH) at a concentration of between 0.01 and 1%. Attempts are subsequently made to remove said chemical products by means of drying and heat.

The use of chemical products, such as H₂O₂ and CH3COOOH poses high risks for both consumers and machine operators. It is risky for consumers when all the peroxide and/or peracetic acid is not successfully removed and residue from them remains, whether significant or residual. It is dangerous for workers or people handling equipment because the products they are handling are toxic and irritating at the concentrations worked with (30-35%). Furthermore, there is a potential environmental risk in terms of storage, handling and residue, as well as in terms of use.

Another negative aspect of chemical sterilisation processes, specifically the process in which hydrogen peroxide is used, is that in time, they provoke harmful effects in many materials and components (such as joints, electronic circuit systems etc.) in both the packaging machinery itself and in nearby equipment. Another negative feature is that these disinfectants have a food oxidation capacity (fats, vitamins) which may affect the nutritional value and organoleptic qualities (aroma, taste and colour) of the food products to be packaged.

Furthermore, the efficacy of these chemical disinfectants is relative or limited, owing to the fact that the contact time must be very short, for productivity reasons; the dosage or concentration of the disinfectants is also limited by them being possible to eliminate completely and quickly, in subsequent stages. The sanitary requirements on the quantity of hydrogen peroxide present in the product, for example those of the FDA (Food and Drug Administration) in the USA, do not allow more than 0.1 ppm (parts per million).

In addition, special processes are being applied in chemical sterilisation, such as the use of ozone for packaging sterilised wine and the use of chlorine or iodine solutions to sterilise stationary and mobile storage tanks. Less radical methods are only used if the alimentary or pharmaceutical products to be packaged have an acidity degree lower than 4.5 (pH≦4.5) and are therefore unaffected by spore-forming bacteria.

In terms of physical treatments applied to packaging materials, specifically to plastic bottles, dry or damp heat (water vapour) have a limited practical application in that they must be applied at temperatures of below 90° C. (depending on the material the bottle is made of i.e. PET, PE, PP), owing to deformation problems thereof. Therefore, UV-C light irradiation is currently incorporated to complement chemical treatments in some aseptic packaging processes.

The bactericidal effect of UV-C light on microorganisms has been known about for over 100 years, in both their vegetative and spore forms. Last century (1910), it was discovered that the genetic material of microorganisms can absorb a maximum of 260 nm UV-C light. The manufacturing of lamps has been perfected ever since the 1940s and in 1955, the first to be made from quartz with wavelengths of 254 nm were obtained, which were truly effective. At the start of the 1980s, the application of UV-C light became popular in the purification of water for food and drink products, as a low cost, safe alternative to improve the taste and smell thereof. By the mid 1990's, UV-C light equipment with medium pressure lamps began to be installed in drinking water systems and to be employed to disinfect the air.

Although UV-C light is considered to be bactericidal, it affects almost all types of microscopic organisms (viruses, bacteria, algae, fungi, yeast and protozoa). The disinfectant capabilities of UV-C light are attributable to its action on the DNA of the cells, reducing the respiratory action thereof, blocking the synthesis processes and inhibiting or delaying mitosis. Moreover, the effect of UV-C light on two contiguous thymine or cytosine (pyrimidines) bases in the same DNA or RNA chain, forms double molecules or dimers, which prevent the DNA or RNA of the microorganisms from duplicating, thereby impeding its reproduction. Reactivation and repair processes may occur by means of photo reactivation via a photo activating enzyme, which inverts the dimerization. However, this usually occurs in extreme laboratory conditions, such as prolonged exposition to high temperatures and wavelength radiations of above 300 nm, something which does not occur in the bottle filling and capping packaging processes, such as in the logical shelf life of any packaged food product.

The operation mechanism of UV-C light is very interesting when it comes to preventing the creation of resistance to treatments by microorganisms. It also prevents sub-lethal damage or injured microorganisms from being generated, which other bactericide treatments produce and which produce false negatives, since over time, this damage can be repaired and the microorganisms can grow and multiply, thus resulting in alterations and contamination in food. These characteristics have been described in other microbial destruction processes, in both physical processes (heat, pressure etc.,) and above all, chemical processes (hydrogen peroxide, disinfectants, etc.)

The bactericide action of UV-C light depends on the intensity and dosage applied. The intensity (I) or irradiance is the amount of UV energy per unit area, measured in microwatts per square centimetre (μW/cm²). The application dosage is calculated by multiplying intensity by time (dosage=Intensity×contact time) and is expressed in Joules per square meter (J/m²) or the equivalent in microWatts second per square centimetre (μW·s/cm²).

Another characteristic of the technology employing UV-C light is that its bactericide effect is cumulative over time (dosage).

Nowadays, the technology used to manufacture UV lamps may produce three basic types of mercury vapour discharge lamp, in general made in tubular form:
1) LP (Low Pressure) hot-cathode mercury lamps;
2) LPHO (Low Pressure High Output) amalgam mercury lamps and;
3) MP (Medium Pressure) mercury lamps.

UV lamps do not usually lose their ability to generate radiation. However, after 8,000 hours of use, their glass polarises and does not transmit the 254 nm wavelength adequately, between 25-30% of its total UV emission thereby being lost. This is disadvantageous since it makes adequate preventative maintenance necessary, for example changing the lamp, the frequency of which depends on how many hours it has been used for and which generally occurs once a year.

UV lamps, also known as bactericide, are similar in design to fluorescent lamps. UV light is emitted as a result of a flow of current (photovoltaic arc) through low pressure mercury vapour between the lamp's electrodes, the majority of its emissions being produced at 254 nm. The bactericide lamp has a pure quartz casing. This is the main difference between a UV lamp and current fluorescent lamps. This pure quartz gives rise to high UV light transmission. In contrast, fluorescent lamps have glass with an inner phosphorous film, which converts UV light into visible light. The quartz tube in the UV light transmits approximately 95% of the UV energy, whereas a glass does not transmit more than 65% and polarises quickly.

The companies which develop this kind of lamp have evolved a lot, creating lamps with high electrical input power and very efficient output in UV-C form (254 nm wavelength). Nevertheless, one of the major problems or disadvantages of using these lamps is that they have certain blind spots, such as the ends (electrodes). These ends are not transmitters and therefore leave shadowed areas which do not receive necessary irradiation.

In order to provide a solution to this limitation, lamps in the form of a U have been designed, the connections of which are located at one end, thus eliminating the blind spot from the other end. This blind spot is a problem when it comes to irradiating UV light in the internal base of the bottles.

Another advantage of these U form lamps is that their power (irradiance) may be increased, without having to increase their length, resulting in shorter exposition times for the same level of bacterial destruction.

The main problem presented by these U form lamps is that, owing to the difficulty of making pure quartz curved, commercial lamps available until now are considerably thick, meaning that they cannot be introduced into the diameter of commercial bottle necks.

For this reason, as a result of substantial improvements in UV-C lamp (curved quartz) manufacturing processes and technology, a series of lamps with characteristics and specific design have been obtained, which are powerful enough and have adequate output efficacy μWatts/cm², a design adapted to mobile mechanisms (robotic arms), with a length or trajectory long enough to cover the entire surface of the glass and plastic (PET, PE, PP, etc.,) bottles most commonly used commercially, without blind spots or shadows existing. This applies particularly to the success of lamps with a narrow enough diameter to be introduced into commercial bottles, which are accepted aesthetically by consumers and which have an internal diameter of 25-30 mm.

To date, in bottling process, the application of UV-C lamps to “narrow” neck bottles was limited to simply irradiating the external surface of these bottles.

Traditionally, plastic and glass bottles are sterilised by means of H₂O₂ solutions at high temperatures and for contact times long enough to successfully sterilise the surface. Therefore, H₂O₂ solutions were traditionally employed to this end, at approximately 30-35%, at temperatures of approximately 80-85° C. and for contact times of at least 20 seconds.

The prior art has demonstrated that the H₂O₂ concentration may be reduced from approximately 0.25 to 5%, when other lethal mechanisms are also employed at the same time. For example, the results obtained in application U.S. Pat. No. 4,289,728 indicate that a logarithmic reduction of Bacillus subtilis spores may be achieved, which is greater than or equal to 4 Log CFU/cm², when such suspension of spores in H₂O₂ at 0.25% is submitted to 30 seconds of UV-C irradiation, followed by heating at 85° C. for 60 seconds. However, this method requires 90 seconds per treatment. Another example is application GB 1,570,492 which reveals that a flat packaging material (polystyrene strips) may be sterilised by means of a sterilising agent formed by H₂O₂ (>20%) and CH3COOOH (0.01-0.5%) in an aqueous solution. Furthermore, this application reveals that reductions of 6 logarithmic units of B. subtilis spores may be achieved, when the H₂O₂/CH3COOOH solution is applied to the surface of the packaging material, followed by a hot air treatment (at 65-86° C.) for an additional 2-12 seconds.

Such high levels of H₂O₂, acids and temperature, alongside relatively long contact times, are necessary to achieve effective surface sterilisation, in order to fulfil the microbiological norms in aseptic packaging operations. However, since the resulting high levels of H₂O₂ may end up in the packaged product, the food industry, for example, is constantly seeking control and/or better alternatives to tackle this problem.

### DESCRIPTION OF THE INVENTION

Bearing the abovementioned disadvantages and limitations in mind, the present invention provides a continuous packaging process in aseptic conditions which comprises a series of stages directed towards packaging alimentary, cosmetic and pharmaceutical products in plastic or glass bottles and their respective caps.

The invention method innovatively comprises, amongst other stages, a stage in which the internal and external surfaces of bottles with a narrow neck and shoulders are sterilised, these bottles having been made from glass or plastic.

In this sterilisation stage, the bottles are submitted to direct irradiation, from the inside of the bottles, emitted by a UV-C light source.

Latest generation U shape lamps are innovatively employed, having a highly efficient power output, these lamps being introduced through the bottle mouth in order to irradiate the entire internal surface.

The present invention advantageously provides a process which does not use chemical methods and which, more specifically, does not use H₂O₂ or CH3COOOH.

The invention process uses UV-C light to sterilise bottles inside and closure caps, which are intended to contain alimentary, cosmetic and pharmaceutical products, comprising the following sequence of stages:
a) preliminary bottle preparation and/or formation;
b) introducing the bottles with caps into a tunnel or cabin, wherein the bottles are submitted to a micro-filtered, over pressurised air flow, at a pressure greater than or equal to 50 KPa (≧0.5 bar) in laminar regime and a set of UV-C lamps irradiates on the entire internal surface of the cabin or tunnel and the external surface of the bottles;
c) removing the caps by means of a robotic or mechanical arm;
d) introducing a UV-C light emitting lamp inside each bottle, this lamp being formed, through a narrow thickness, to irradiate on the entire external and internal surface of the bottles in order to prevent blind spots;
e) filling the bottle with the alimentary, cosmetic or pharmaceutical product using an aseptic watertight valve;
f) irradiating the internal surface of the caps, as they are moved along an open channel;
g) closing the bottles with the irradiated caps, by means of a robotic or mechanised arm.

One option of the process in characterised in that the preliminary preparation stage a) entails blowing and moulding preforms in order to form and obtain bottles. This option offers the possibility of introducing a line for forming and obtaining bottles which precedes the aseptic packaging line for alimentary, cosmetic and pharmaceutical products.

Another option of the process is that the preliminary preparation stage a) entails thermally treating the bottles with a cap by means of pressurised steam in an autoclave.

The present invention process adds the following advantages to the art:
not using disinfectant chemical products, such as H₂O₂ and CH3COOOH, which means that the risk of chemical residues being present in the container or packaging is eliminated;
irradiation coming from the type C UV light source, which is applied in the invention process, is applied to the entire inner surface and base of the bottle, thus preventing blind spots or areas;
the external diameter of the type C UV light lamp facilitates its access through the narrow openings in plastic or glass bottles which are usually used in the alimentary, cosmetic and pharmaceutical industries;
microbiological contamination is prevented and the microbial load of the container intended to package the food, pharmaceutical product etc., and the cap is even reduced, if there to start with;
the presence of vegetative forms and microorganism spores is reduced and;
the number of microorganisms in both dry state and wet state is reduced.

### DESCRIPTION OF THE DRAWINGS

FIG. 1 represents the introduction of the U shape UV-C(2) lamp into the bottle (1) in order to irradiate the internal surface therein.

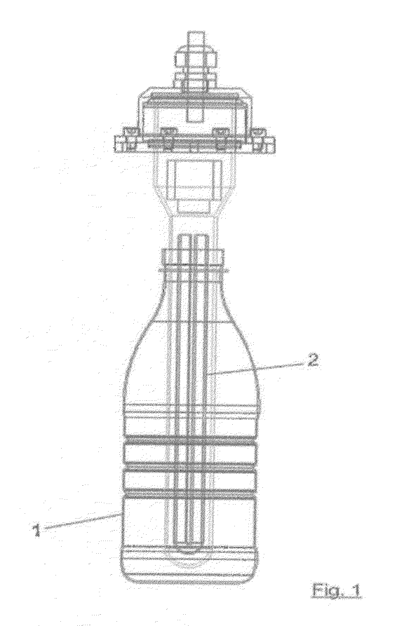

The present invention is described below using the following examples of embodiment.

### Example 1

In this example, the process begins with a preliminary treatment of the bottles with a cap, which are intended to contain an alimentary product. These bottles are submitted to the following sequence of stages:

1.a) the bottles with a cap are submitted to a thermal treatment by means of pressurised steam in an autoclave;

1.b) the bottles with a cap are introduced into an aseptic tunnel or cabin, wherein they will remain until the end of the process (capping), upon which a flow of micro-filtered, over pressurized air is applied, at a pressure greater than or equal to 50 KPa (≧0.5 bar) in a laminar regime and wherein the entire internal surface of the cabin or tunnel and the entire external surface of the bottles are irradiated by means of a set of UV-C lamps;

1.c) removing the bottle caps by means of a robotic or mechanical arm;

1.d) introducing a UV-C lamp (2) into the inside of each bottle (1), wherein said lamp is in the form of a U in order to prevent blind spots and has an output power greater than or equal to 3 μW/cm² with a diameter of less than or equal to 35 mm, the same adapting to the robotic or mechanical arms;

1.e) filling the bottle with the alimentary product, through an aseptic watertight valve;

1.f) irradiating the internal surface of the caps as they are moved along an open channel;

1.g) closing the bottles with the irradiated caps, by means of a robotic or mechanized arm.

### Example 2

In this example, the invention method begins with bottles with a cap which have been previously blown, moulded, formed and capped, coming from an external sub-process. The bottles are intended to contain a pharmaceutical product and are submitted to the following sequence of stages:

2.a) the bottles with a cap are introduced into an aseptic tunnel or cabin, applying a micro-filtered, over pressurized air flow at a pressure of greater than or equal to 50 KPa (≧0.5 bar) in a laminar regime, wherein the entire internal surface of the cabin or tunnel and the entire external surface of the bottles are irradiated, by means of a set of UV-C lamps;

2.b) removing the bottle caps by means of a robotic or mechanical arm;

2.c) introducing a UV-C lamp (2) into the inside of each bottle (1), wherein said lamp is in the form of a U in order to prevent blind spots and has an output power (output irradiance) greater than or equal to 3 μW/cm² with a diameter less than or equal to 35 mm, the same adapting to the robotic or mechanical arms;

2.d) filling the bottle with a pharmaceutical product, through an aseptic watertight valve;

2.e) irradiating the inner surface of the caps as they are moved along an open channel;

2.f) closing the bottles with the irradiated caps, by means of a robotic or mechanised arm.

### Example 3

3.a) In this third example, there is a preliminary bottle formation stage for bottles intended to contain a cosmetic product. In this stage, preforms, from whose surface possible particles are extracted by means of air pressure cleaning, are submitted to hot air pressure blowing and thermal moulding, in order to obtain bottles.

Once the bottles have been formed, they are subsequently sent to the next series of stages directly for a continuous process:

3.b) introducing the warm bottle into an aseptic tunnel or cabin, wherein they will remain until the end of the process (capping), applying the same characteristics as in stages 1b (example 1) and stage 2a (example 2):

3.c) removing the bottle caps by means of a robotic or mechanical arm;

3.d) introducing a UV-C lamp (2) into the inside of each bottle (1), wherein said lamp is in the form of a U in order to prevent blind spots, with an output power greater than or equal to 3 μW/cm² and a diameter less than or equal to 35 mm, adapting to the robotic or mechanical arms;

3.e) filling the bottle with a cosmetic product through an aseptic watertight valve;

3.f) irradiating the internal surface of the caps, whilst they are moved along an open channel;

3.g) closing the bottles with the irradiated caps, by means of a robotic or mechanised arm.

In order to demonstrate the efficacy of the present invention and particularly of the stage in which the UV-C light lamp is introduced inside the bottles, which is the most effective stage of all those stages forming the invention process, the survival rate or lethality of various microorganisms (bacteria and mould) have been studied, as well as various physiological states (vegetative and sporulated) in order to obtain an ample representative sample of their behaviour or survival in relation to UV light on the inner surface of the bottles. The strains tested were as follows:
Staphylococcus aureus CECT 534
Escherichia coli CECT 405
Listeria innocua CECT 910
Lactobacillus helveticus CECT 414
Pseudomonas fluorescens CECT 378
Bacillus subtilis (spores) CECT 4002
Aspergillus niger (spores) CECT 2574

The strains were inoculated in a uniform way on the entire interior of the PET (polyethylene terephthalate) and PP (polypropylene) bottles and the HDPE (high density polyethylene) caps, wherein concentrations of between 106 and 108 cfu/cm² were reached, depending on the microorganism. The internal surfaces were dried in sterile conditions for at least 6 hours.

The UV lamp was introduced completely in the inside of the bottles for differing amounts of time—3, 6, 12, 30, 60 and 120 seconds. The output distance and power in UV-C light form were graduated in order to obtain the following irradiance values, respectively—2.5, 5.0, 7.2, 10.5, 19 and 35 μW/cm². All the trials were carried out at room temperature.

The efficacy of the stage in which an UV-C light is introduced inside the bottles is illustrated in Tables 1-8, which contain the results obtained.

TABLE 1
Effect on lethality by means of UV-C light treatments with irradiance of 19 μW/cm² during several
exposure times on different microorganisms inoculated on the internal surface of PET bottles.

| | TIME (seconds) exposure | | | | | |
|---|---|---|---|---|---|---|
| | 3 s | 6 s | 12 s | 30 s | 60 s | 120 s |
| | X̅ SD | X̅ SD | X̅ SD | X̅ SD | X̅ SD | X̅ SD |
| B. subtilis (spores) | 1.06 ± 0.31 | 2.5 ± 0.16 | 4.04 ± 0.96 | 5.85 ± 0.76 | ≧6.5 ± 0.21 | ≧6.5 ± 0.21 |
| S. aureus | 2.1 ± 0.22 | 4.53 ± 0.48 | 6.65 ± 0.44 | ≧7.1 ± 0.33 | ≧7.1 ± 0.33 | ≧7.1 ± 0.33 |
| E. coli | 2.96 ± 0.61 | 5.97 ± 0.73 | 7.1 ± 0.21 | ≧7.2 ± 0.25 | ≧7.2 ± 0.25 | ≧7.2 ± 0.25 |
| L. innocua | 2.01 ± 0.55 | 3.62 ± 0.65 | 6.04 ± 0.48 | ≧6.9 ± 0.3 | ≧6.9 ± 0.3 | ≧6.9 ± 0.3 |
| L. helveticus | 1.55 ± 0.52 | 2.86 ± 1.12 | 6.52 ± 0.36 | ≧6.8 ± 0.25 | ≧6.8 ± 0.25 | ≧6.8 ± 0.25 |
| P. fluorescens | 1.66 ± 0.43 | 4.26 ± 0.78 | 5.82 ± 0.67 | ≧6.5 ± 0.18 | ≧6.5 ± 0.18 | ≧6.5 ± 0.18 |
| A. niger (spores) | 0.29 ± 0.14 | 1.08 ± 0.22 | 1.29 ± 0.65 | 3.1 ± 0.44 | 4.26 ± 0.78 | ≧5.1 ± 0.38 |

X̅ (Mean), SD (Standard Deviation).
Lethality (Log N/N_{f}) in cfu/cm²
Data from three independent experiments with duplicate analyses (n = 6)

TABLE 2
Effect on lethality by means of UV-C light treatments with irradiance of 19 μW/cm² during several
exposure times on different microorganisms inoculated on the internal surface of PP bottles.

| | TIME (seconds) exposure | | | | | |
|---|---|---|---|---|---|---|
| | 3 s | 6 s | 12 s | 30 s | 60 s | 120 s |
| | X̅ SD | X̅ SD | X̅ SD | X̅ SD | X̅ SD | X̅ SD |
| B. subtilis (spores) | 0.8 ± 0.24 | 1.8 ± 0.22 | 4.29 ± 0.55 | 6.5 ± 0.35 | ≧6.7 ± 0.18 | ≧6.7 ± 0.18 |
| S. aureus | 1.94 ± 0.15 | 3.88 ± 0.42 | 6.7 ± 0.33 | ≧6.9 ± 0.25 | ≧6.9 ± 0.25 | ≧6.9 ± 0.25 |
| E. coli | 2.55 ± 0.47 | 5.1 ± 0.61 | 7 ± 0.4 | ≧7.2 ± 0.27 | ≧7.2 ± 0.27 | ≧7.2 ± 0.27 |
| L. innocua | 1.88 ± 0.66 | 2.78 ± 0.54 | 6.8 ± 0.25 | ≧7.1 ± 0.24 | ≧7.1 ± 0.24 | ≧7.1 ± 0.24 |
| L. helveticus | 1.4 ± 0.38 | 2.54 ± 0.94 | 6.4 ± 0.44 | ≧6.9 ± 0.31 | ≧6.9 ± 0.31 | ≧6.9 ± 0.31 |
| P. fluorescens | 1.58 ± 0.33 | 3.27 ± 0.83 | 6.46 ± 0.38 | ≧7.1 ± 0.22 | ≧7.1 ± 0.22 | ≧7.1 ± 0.22 |
| A. niger (spores) | 0.3 ± 0.21 | 0.46 ± 0.15 | 1.4 ± 0.47 | 2.98 ± 0.35 | 4.4 ± 0.58 | ≧5.3 ± 0.41 |

X̅ (Mean), SD (Standard Deviation).
Lethality (Log N/Nf) in cfu/cm²
Data from three independent experiments with duplicate analyses (n = 6)

TABLE 3
Effect on lethality by means of UV-C light treatments with irradiance of 19 μW/cm² during several
exposure times on different microorganisms inoculated on the internal surface of HDPE caps.

| | TIME (seconds) exposure | | | | | |
|---|---|---|---|---|---|---|
| | 3 s | 6 s | 12 s | 30 s | 60 s | 120 s |
| | X̅ SD | X̅ SD | X̅ SD | X̅ SD | X̅ SD | X̅ SD |
| B. subtilis (spores) | 1.12 ± 0.24 | 2.92 ± 0.33 | 4.51 ± 0.72 | 6.7 ± 0.23 | ≧6.8 ± 0.12 | ≧6.8 ± 0.12 |
| S. aureus | 2.43 ± 0.44 | 4.8 ± 0.51 | 7.1 ± 0.31 | ≧7.3 ± 0.22 | ≧7.3 ± 0.22 | ≧7.3 ± 0.22 |
| E. coli | 3.22 ± 0.38 | 5.49 ± 0.58 | 7.2 ± 0.21 | ≧7.4 ± 0.15 | ≧7.4 ± 0.15 | ≧7.4 ± 0.15 |
| L. innocua | 2.1 ± 0.64 | 3.8 ± 0.43 | 7.52 ± 0.14 | ≧7.6 ± 0.12 | ≧7.6 ± 0.12 | ≧7.6 ± 0.12 |
| L. helveticus | 1.63 ± 0.55 | 3.64 ± 0.78 | 6.58 ± 0.22 | ≧6.7 ± 0.31 | ≧6.7 ± 0.31 | ≧6.7 ± 0.31 |
| P. fluorescens | 1.44 ± 0.23 | 4.95 ± 1.11 | 6.6 ± 0.26 | ≧6.9 ± 0.24 | ≧6.9 ± 0.24 | ≧6.9 ± 0.24 |
| A. niger (spores) | 0.6 ± 0.11 | 1.16 ± 0.31 | 1.78 ± 0.54 | 3.6 ± 0.51 | 5.2 ± 0.24 | ≧5.5 ± 0.23 |

X̅(Mean), SD (Standard Deviation).
Lethality (Log N/Nf) in cfu/cm²
Data from three independent experiments with duplicate analyses (n = 6)

TABLE 4
Effect on lethality by means of UV-C light treatments lasting 6 seconds with several irradiance
exposures on different microorganisms, inoculated on the internal surface of PET bottles.

| | IRRADIANCE (mW/cm 2) | | | | | |
|---|---|---|---|---|---|---|
| | 2.5 | 5 | 7.2 | 10.5 | 19 | 35 |
| | X̅ SD | X̅ SD | X̅ SD | X̅ SD | X̅ SD | X̅ SD |
| B. subtilis (spores) | 0.41 ± 0.35 | 0.88 ± 0.44 | 1.1 ± 0.36 | 1.7 ± 0.52 | 2.5 ± 0.41 | 5.4 ± 0.23 |
| S. aureus | 0.71 ± 0.12 | 1.6 ± 0.38 | 2.53 ± 0.42 | 3.3 ± 0.78 | 4.53 ± 0.54 | ≧6.9 ± 0.28 |
| E. coli | 1.15 ± 0.23 | 1.89 ± 0.21 | 2.9 ± 0.33 | 4.54 ± 1.1 | 5.97 ± 0.64 | ≧7.1 ± 0.24 |
| L. innocua | 0.76 ± 0.31 | 1.4 ± 0.61 | 1.74 ± 0.25 | 3.1 ± 0.78 | 3.62 ± 0.73 | ≧6.8 ± 0.33 |
| L. helveticus | 0.8 ± 0.32 | 1 ± 0.33 | 1.5 ± 0.41 | 2.6 ± 0.65 | 2.86 ± 0.44 | ≧7.1 ± 0.25 |
| P. fluorescens | 0.63 ± 0.41 | 1.55 ± 0.26 | 1.74 ± 0.5 | 2.41 ± 0.63 | 4.26 ± 0.58 | 7.03 ± 0.15 |
| A. niger (spores) | 0.11 ± 0.05 | 0.15 ± 0.07 | 0.5 ± 0.18 | 0.44 ± 0.21 | 1.08 ± 0.15 | 1.55 ± 0.2 |

X̅ (Mean), SD (Standard Deviation).
Lethality (Log N/Nf) in cfu/cm²
Data from three independent experiments with duplicate analyses (n = 6)

TABLE 5
Effect on lethality by means of UV-C light treatments for 6 seconds with several irradiance
exposures on different microorganisms, inoculated on the internal surface of PP bottles.

| | IRRADIANCE (mW/cm²) | | | | | |
|---|---|---|---|---|---|---|
| | 2.5 | 5 | 7.2 | 10.5 | 19 | 35 |
| | X̅ SD | X̅ SD | X̅ SD | X̅ SD | X̅ SD | X̅ SD |
| B. subtilis (spores) | 0.32 ± 0.22 | 0.55 ± 0.26 | 1.16 ± 0.22 | 1.49 ± 0.38 | 1.8 ± 0.32 | 5.32 ± 0.44 |
| S. aureus | 0.62 ± 0.14 | 1.38 ± 0.31 | 1.96 ± 0.26 | 2.9 ± 0.45 | 3.88 ± 0.36 | ≧7.01 ± 0.15 |
| E. coli | 0.9 ± 0.31 | 2.14 ± 0.19 | 2.37 ± 0.32 | 4.1 ± 0.66 | 5.1 ± 0.44 | ≧7.2 ± 0.22 |
| L. innocua | 0.65 ± 0.24 | 1.33 ± 0.45 | 1.7 ± 0.41 | 2.9 ± 0.75 | 2.78 ± 0.64 | ≧6.9 ± 0.21 |
| L. helveticus | 0.55 ± 0.22 | 1.6 ± 0.39 | 1.8 ± 0.44 | 2.2 ± 0.89 | 2.54 ± 0.51 | 6.5 ± 0.36 |
| P. fluorescens | 0.46 ± 0.18 | 1.42 ± 0.33 | 1.55 ± 0.38 | 2.4 ± 0.44 | 3.27 ± 0.67 | 6.9 ± 0.34 |
| A. niger (spores) | 0.1 ± 0.04 | 0.16 ± 0.08 | 0.31 ± 0.08 | 0.56 ± 0.13 | 0.46 ± 0.21 | 1.46 ± 0.31 |

X̅ (Mean), SD (Standard Deviation).
Lethality (Log Nᵢ/N_{f}) in cfu/cm²
Data from three independent experiments with duplicate analyses (n = 6)

TABLE 6
Effect on lethality by means of UV-C light treatments for 6 seconds, with several irradiance
exposures on different microorganisms, inoculated on the internal surface of HDPE caps.

| | IRRADIANCE (mW/cm²) | | | | | |
|---|---|---|---|---|---|---|
| | 2.5 | 5 | 7.2 | 10.5 | 19 | 35 |
| | X̅ SD | X̅ SD | X̅ SD | X̅ SD | X̅ SD | X̅ SD |
| B. subtilis (spores) | 0.44 ± 0.31 | 0.8 ± 0.23 | 1.5 ± 0.24 | 1.75 ± 0.31 | 2.92 ± 0.37 | 6 ± 0.55 |
| S. aureus | 0.73 ± 0.25 | 1.51 ± 0.47 | 2.8 ± 0.36 | 3.2 ± 0.64 | 4.8 ± 0.36 | ≧7.2 ± 0.13 |
| E. coli | 1.12 ± 0.18 | 2.44 ± 0.34 | 3.01 ± 0.37 | 4.48 ± 0.96 | 5.49 ± 0.51 | ≧7.15 ± 0.24 |
| L. innocua | 0.81 ± 0.27 | 1.65 ± 0.69 | 2 ± 0.29 | 3.18 ± 0.65 | 3.8 ± 0.48 | ≧6.88 ± 0.28 |
| L. helveticus | 0.63 ± 0.25 | 1.38 ± 0.47 | 1.7 ± 0.24 | 2.77 ± 0.71 | 3.64 ± 0.39 | ≧7.2 ± 0.21 |
| P. fluorescens | 0.66 ± 0.19 | 1.33 ± 0.45 | 2.1 ± 0.55 | 2.38 ± 0.53 | 4.95 ± 0.64 | 6.98 ± 0.25 |
| A. niger (spores) | 0.2 ± 0.05 | 0.21 ± 0.04 | 0.5 ± 0.12 | 0.51 ± 0.15 | 1.16 ± 0.17 | 1.62 ± 0.27 |

X̅(Mean), SD (Standard Deviation).
Lethality (Log Nᵢ/Nf) in cfu/cm²
Data from three independent experiments with duplicate analyses (n = 6)

TABLE 7
Kinetics of microbial inactivation (regression lines) depending
on the application time (in seconds) for irradiance of 19 μW/cm²

| | | | | | K (i) | Ster (i) |
|---|---|---|---|---|---|---|
| | | | | | (19 | (19 |
| | m | b | r | r² | mW/cm²) | mW/cm²) |
| B. subtilis | 0.183 | 1.17 | 0.95335 | 0.90887 | 5.5 | 27.5 |
| (spores) | | | | | | |
| S. aureus | 0.501 | 0.95 | 0.98567 | 0.97155 | 2 | 10 |
| E. coli | 0.437 | 2.12 | 0.94568 | 0.89431 | 2.3 | 11.5 |
| L. innocua | 0.537 | 0.31 | 0.99901 | 0.99802 | 1.9 | 9.5 |
| L. helveticus | 0.557 | −0.22 | 0.99928 | 0.99856 | 1.8 | 9 |
| P. fluorescens | 0.502 | 0.49 | 0.96965 | 0.94023 | 2 | 10 |
| A. niger | 0.073 | 0.51 | 0.9806 | 0.96158 | 13.7 | 68.5 |
| (spores) | | | | | | |

m (slope of de line), b (constant of the line), r (correlation coefficient), r² (determination coefficient) K (i), time (seconds) required to reduce a microorganism 1 logarithmic cycle with an exposure Irradiance of 19 mW/cm^{2.}
Ster (i), time (seconds) required to reduce a microorganism 5 logarithmic cycles with an exposure Irradiance of 19 mW/cm².
Data from three independent experiments with duplicate analyses (n = 6)

TABLE 8
Kinetics of microbial inactivation (regression lines) as a function
of irradiance applied (19 μW/cm²) for an exposure time of 6 seconds.

| | | | | | K (t) | Ster (t) |
|---|---|---|---|---|---|---|
| | | | | | (6 sec- | (6 sec- |
| | m | b | r | r | onds) | onds) |
| B. subtilis | 0.154 | −0.03 | 0.99096 | 0.982 | 6.5 | 32.5 |
| (spores) | | | | | | |
| S. aureus | 0.219 | 0.49 | 0.97299 | 0.94671 | 4.6 | 23 |
| E. coli | 0.268 | 0.81 | 0.96425 | 0.92978 | 3.7 | 18.5 |
| L. innocua | 0.161 | 0.67 | 0.92571 | 0.85694 | 6.2 | 31 |
| L. helveticus | 0.139 | 0.61 | 0.94845 | 0.89956 | 7.2 | 36 |
| P. fluorescens | 0.192 | 0.36 | 0.99784 | 0.99568 | 5.2 | 26 |
| A. niger | 0.044 | 0.04 | 0.99442 | 0.98887 | 22.9 | 114.5 |
| (spores) | | | | | | |

m (slope of the line), b (constant of the line), r (correlation coefficient), r² (determination coefficient) K (t), Irradiance (mW/cm²) required to reduce a microorganism 1 logarithmic cycle with an exposure time of 6 seconds.
Ster (t), Irradiance (mW/cm²) required to reduce a microorganism 5 logarithmic cycles with an exposure time of 6 seconds.
Data from three independent experiments with duplicate analyses (n = 6)

The following observations have been made on the results obtained by applying the invention process:

The data included in the above tables (1-8) provide a summary of the following, most relevant results:
Lethality increases in a linear, proportional way with longer exposition times, at least in the range of the first 3 to 12 seconds.
At higher exposition intensities, lethality increases in a linear and proportional way, at least in the 2.5 to 10.5 μW/cm² range.
When intensities of 19 μW/cm² are applied, for between 6 to 12 seconds, lethalities (reductions) are achieved in vegetative bacteria of between 2 to 7 logarithmic units (Log), whilst in microorganisms which are more resistant to UV light, for example B. subtilis spores and A. niger spores, lethalities of between 2 and 4 log and between 0.5 and 2 Log were achieved, respectively.
The container or packaging material tested, namely PET, PP and HDPE, did not present any limitation in terms of obtaining satisfactory results.
In relatively “clean” bottles and caps, relatively clean understood to mean those bottles and caps with loads lower than 120 cfu/cm², the application during between 6 and 12 seconds (at intensities of 19 μW/cm²) would be more than enough to produce an aseptic packaging or, at least, in aseptic conditions.

1. Continuous packaging process using UV-C light to sterilize the inside of bottles and closure caps intended to contain alimentary, cosmetic and pharmaceutical products, comprising the following sequence of stages:
a) preliminarily preparing and/or forming the bottles;
b) introducing the bottles with a cap into a tunnel or cabin, wherein the bottles are submitted to a micro-filtered, over pressurized air flow, at a pressure greater than or equal to 50 KPa in a laminar regime and a set of UV-C lamps irradiates on the entire internal surface of the cabin or tunnel and the external surface of the bottles;
c) removing the caps by means of a robotic or mechanical arm;
d) introducing a UV-C emitting lamp inside each bottle, the lamp being formed with a narrow thickness in order to irradiate the entire internal surface of the bottles, thereby preventing blind spots;
e) filling the container with the alimentary, cosmetic or pharmaceutical product through an aseptic watertight valve;
f) irradiating the internal surface of the caps with UV light whilst they are moved along an open channel;
g) closing the bottles with the irradiated caps, by means of a robotic or mechanised arm.

2. Process according to claim 1, wherein the preliminary preparation stage a) consists of blowing and moulding preforms to form and obtain bottles.

3. Process according to claim 1, wherein the preliminary preparation stage a) consists of applying a thermal treatment by means of pressurised steam in an autoclave to the bottles with a cap.
